(19) United States
(12) Patent Application Publication
(10) Pub. No.: US 2026/0121136 A1
(43) Pub. Date: Apr. 30, 2026

(54) SIMULTANEOUS ANALOG AND DIGITAL COMMUNICATIONS OVER BATTERY PACK TERMINAL

(71) Applicant: MILWAUKEE ELECTRIC TOOL CORPORATION, Brookfield, WI (US)

(72) Inventors: Andrew J. Paskov, Brookfield, WI (US); Michael C. Hallman, Greenfield, WI (US)

(21) Appl. No.: 19/363,870

(22) Filed: Oct. 21, 2025

Related U.S. Application Data
(60) Provisional application No. 63/710,730, filed on Oct. 23, 2024.

(51) Int. Cl. H01M 10/42; H01M 10/48; H01M 50/247

(52) U.S. Cl. CPC H01M 10/425; H01M 10/48; H01M 50/247; H01M 2010/4278; H01M 2220/30

(57) ABSTRACT

A system includes a power tool including a battery pack interface and a battery pack configured to connect to the battery pack interface. The battery pack is configured to superimpose a digital signal onto an analog signal to generate a composite signal. The battery pack is configured to transmit the composite signal to the power tool via the battery pack interface. The power tool is configured to separate the composite signal into an analog component and a digital component.

### RELATED APPLICATIONS

This application claims the benefit of U.S. Provisional Patent Application No. 63/710,730, filed Oct. 23, 2024, the entire content of which is hereby incorporated by reference.

### FIELD

This disclosure relates to power tools and, more particularly, to battery pack powered power tools.

### SUMMARY

Providing a standardized interface format for power tool battery packs offers a range of technical and practical advantages. For examples, standardizing the interface format allows users to easily swap battery packs between different tools, eliminating the need for a unique battery pack for each tool. This interoperability ensures that when a battery pack fails or runs out of charge, it can be quickly replaced with another, potentially even from a different tool, minimizing downtime during time-sensitive or critical operations. Furthermore, providing a standardized interface format allows different battery packs to be charged using a single charger or type of charger. This interoperability not only simplifies the user experience but also enhances the overall flexibility and scalability of a power tool systems, allowing users to build larger, more versatile toolsets without being constrained by battery compatibility issues.

Some standardized interface formats were originally designed when communication between the battery pack and the power tool was limited to basic analog signals. Analog communication is typically sufficient for transmitting simple parameters, such as voltage and temperature, between the battery pack and the tool. However, as modern power tools have evolved to incorporate more advanced features (including, for example, real-time performance monitoring, predictive maintenance, adaptive power management, user-configurable settings, and more), fully implementing these features may require more sophisticated data exchange between the battery pack and the power tool. For example, these intelligent features may demand higher data throughput, greater bandwidth, and faster response times than analog communications signals can provide. As a result, modern power tools increasingly rely on digital communication protocols between the battery pack and the tool to support these capabilities.

As new power tools with advanced features relying on digital communication protocols are introduced, it may still be technically advantageous to maintain the existing standardized interface format. This is because the standardized interface format may offer a high degree of compatibility and user convenience, which may have been established over time as a key benefit for a power tool system. However, some legacy standardized interface formats may come with certain physical and electrical limitations. For example, in interface designs that use a limited number of communication terminals, such as a single terminal for data exchange, it may not be practical to add additional digital communication terminals without compromising the form factor or overall compatibility of the legacy standardized interface format. Maintaining the standardized interface format ensures that users can continue to use legacy chargers and tools with new battery packs, preserving the system's value.

Furthermore, many legacy tools may still rely on analog communications over the existing terminal to transmit operating parameters such as voltage and temperature. To ensure backward compatibility with these legacy tools, it is technically beneficial to maintain the ability to communicate using analog signals over the same signal. However, because advanced modern tools may rely on digital communication to support advanced features, one technical challenge is how to facilitate both analog and digital communication over an existing terminal without altering the standardized interface.

Systems, apparatuses, methods, and techniques described herein provide technical solutions to these challenges (among others) by superimposing a digital signal on top of an analog signal to facilitate both analog and digital communications over the same communication terminal. For example, by leveraging one or more modulation techniques, a digital signal can coexist with the analog signal on the same terminal, allowing for simultaneous analog and digital communication. This approach facilitates digital data exchange for modern power tools while preserving the analog communication ability necessary for legacy tools (and without requiring physical alterations to the standardized interface format).

In various implementations, the digital signal may be superimposed in a way that does not interfere with the analog signals, such as using frequency-division and/or time-division multiplexing techniques (or other techniques described herein). These technical solutions ensure backwards compatibility with legacy power tools and chargers while providing the necessary communications bandwidth for supporting more advanced modern features. As a result, users can seamlessly transition to newer, advanced power tools without losing compatibility with their existing equipment.

A power tool includes a battery pack interface, a signal processing unit connected to the battery pack interface, and an electronic controller connected to the signal processing unit. The battery pack interface is configured to receive a composite signal from a battery pack. The signal processing unit is configured to separate the composite signal into an analog component and a digital component. The electronic controller is configured to receive the analog component and the digital component from the signal processing unit.

In other features, the signal processing unit includes a first signal processing unit configured to isolate the analog component from the composite signal. In other features, the first signal processing unit includes a voltage tracking circuit. In other features, the voltage tracking circuit tracks substantially continuous voltage levels of the composite signal. The substantially continuous voltage levels represent the analog component. In other features, the signal processing unit includes a second signal processing unit configured to isolate the digital component from the composite signal. In other features, the second signal processing unit includes a voltage tracking circuit.

In other features, the voltage tracking circuit identifies high-frequency voltage peaks of the composite signal. The high-frequency voltage peaks represent the digital component. In other features, the composite signal is generated at a battery pack. In other features, the battery pack is configured to generate the composite signal by superimposing a digital signal onto an analog signal. In other features, the analog signal represents an operational parameter of the battery pack.

A battery pack system includes a power tool including a battery pack interface and a battery pack. The battery pack includes a communication terminal configured to connect to a battery pack interface of a power tool, a signal processing unit connected to the communication terminal, and an electronic controller connected to the signal processing unit. The electronic controller is configured to generate an analog signal and a digital signal. The signal processing unit is configured to superimpose the digital signal onto the analog signal to generate a composite signal. The communication terminal is configured to transmit the composite signal to the battery pack interface.

In other features, the analog signal represents an operational parameter of the battery pack. In other features, the power tool is configured to receive the composite signal and separate the composite signal into an analog component and a digital component. In other features, the power tool includes a first signal processing unit configured to isolate the analog component from the composite signal. In other features, the first signal processing unit includes a voltage tracking circuit.

In other features, the voltage tracking circuit tracks substantially continuous voltage levels of the composite signal. The substantially continuous voltage levels represent the analog component. In other features, the signal processing unit includes a second signal processing unit configured to isolate the digital component from the composite signal. In other features, the second signal processing unit includes a voltage tracking circuit. In other features, the voltage tracking circuit identifies high-frequency voltage peaks of the composite signal. The high-frequency voltage peaks represent the digital component.

A system includes a power tool including a battery pack interface and a battery pack configured to connect to the battery pack interface. The battery pack is configured to superimpose a digital signal onto an analog signal to generate a composite signal. The battery pack is configured to transmit the composite signal to the power tool via the battery pack interface. The power tool is configured to separate the composite signal into an analog component and a digital component.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other examples, embodiments, features, and aspects will become apparent by consideration of the detailed description and accompanying drawings.

### BRIEF DESCRIPTION OF THE DRAWINGS

FIG. 1 illustrates a system including one or more power tools and one or more battery packs sharing a common standardized interface format, according to some embodiments.

FIG. 2 is a side view of an example power tool with an example battery pack attached, according to some embodiments.

FIG. 3 is a partial view of a portion of the power tool of FIG. 2, according to some embodiments.

FIG. 4 is a block diagram illustrating an example control system for the power tool of FIG. 2, according to some embodiments.

FIG. 5 is an isometric view of an example battery pack, according to some embodiments.

FIG. 6 is an exploded view of the example battery pack of FIG. 5, according to some embodiments.

FIG. 7 is a top view of the example battery pack of FIG. 5, according to some embodiments.

FIG. 8 is an isometric view of the example battery pack of FIG. 5, according to some embodiments.

FIG. 9 is a side view of the example battery pack of FIG. 5, according to some embodiments.

FIG. 10 is a rear view of the example battery pack of FIG. 5, according to some embodiments.

FIG. 11 is a block diagram illustrating an example control system for the battery pack of FIG. 5, according to some embodiments.

FIG. 12 is a flowchart illustrating an example process for simultaneous analog and

digital communication between a battery pack and a power tool, according to some embodiments.

FIG. 13 is a chart illustrating an example of a combined signal, according to some embodiments.

In the drawings, reference numbers may be reused to identify similar and/or identical elements.

### DETAILED DESCRIPTION

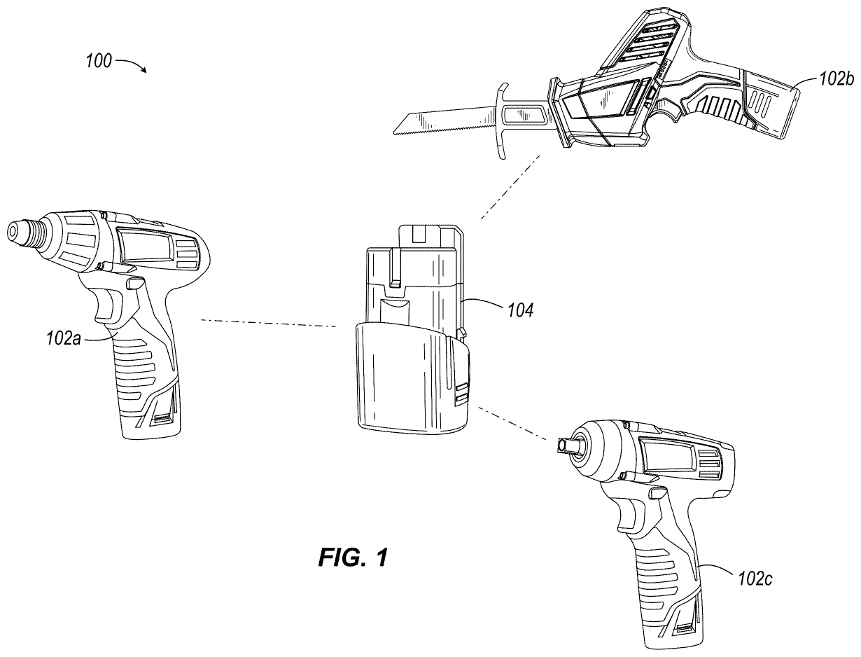

FIG. 1 illustrates a system 100 including one or more power tools 102 and one or more battery packs 104 sharing a common standardized interface format, according to some embodiments. In the example of FIG. 1, the system 100 includes a first power tool 102a, a second power tool 102b, a third power tool 102c, and a battery pack 104. While three power tools 102 and a single battery pack 104 are illustrated in the example of FIG. 1, other implementations of the system 100 may include any number and type of power tools 102 and any number and type of battery packs 104 sharing the standardized interface format.

In the example of FIG. 1, the power tool 102a is a drill, the power tool 102b is an impact driver, and the power tool 102c is a reciprocating saw. However, the system 100 can be implemented with any combination of power tools (such as, for example, drills, impact drivers, circular saws, reciprocating saws, angle grinders, sanders, nail guns, lawn mowers, leaf blowers, hedge trimmers, string trimmers, and/or chainsaws, etc.) and/or other devices powered by the battery packs 104 (such as, for example, lights, portable radios, portable air compressors, wet/dry vacuums, and/or or portable power stations for charging electronic devices, etc.).

While the power tools 102, other devices, and/or battery packs 104 vary in power requirements, form factor, and functionality, they may all include the same standardized interface format. A standardized interface format may refer to a uniform set of physical and electrical connections between the power tools 102 and the battery packs 104 and/or between the other devices and the battery packs 104, which allows the battery packs 104 to be used across a wide range of power tools 102 and/or other devices without requiring tool or device specific batteries or chargers.

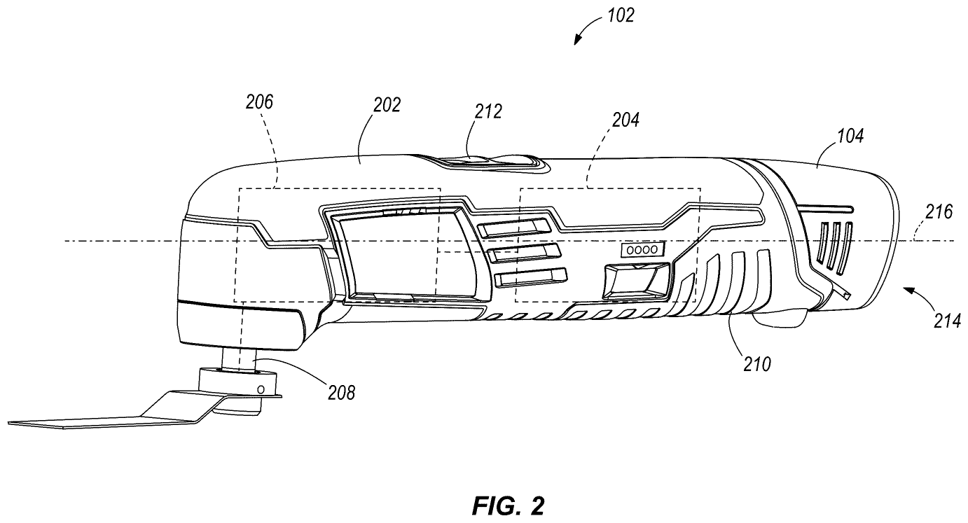

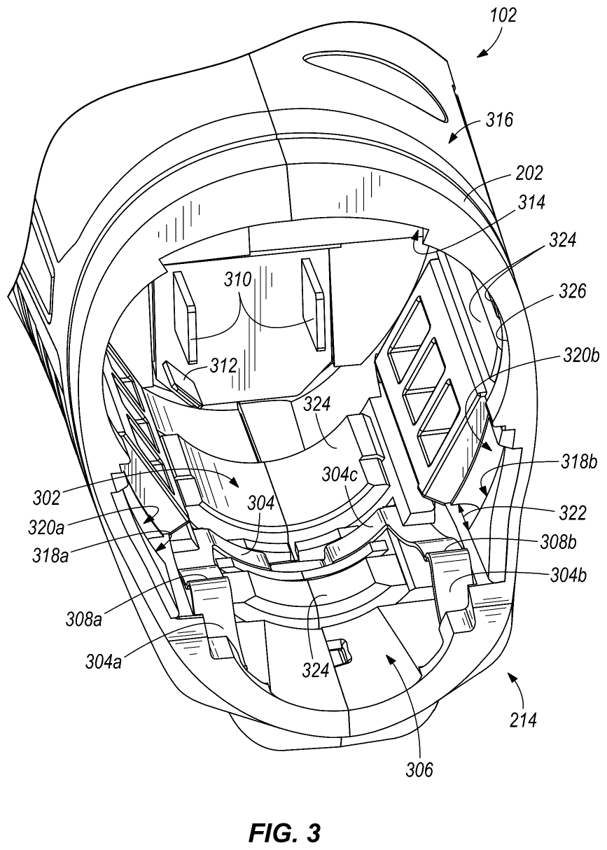

FIG. 2 is a side view of an example power tool 102 with an example battery pack 104 attached, according to some embodiments. FIG. 3 is a partial view of a portion of the power tool 102 of FIG. 2, according to some embodiments. Referring collectively to FIGS. 2 and 3, the power tool 102 may include a housing 202 that contains a motor 204 positioned substantially within the housing 202. The motor 204 may be mechanically coupled to a drive mechanism 206, which in turn may be mechanically coupled to an output element 208. The motor 204 may be operable to transfer mechanical power to the drive mechanism 206, which in turn transfers mechanical power to the output element 208. In the example of FIG. 2, the drive mechanism 206 is an eccentric drive mechanism and the output element 208 is an oscillating member.

In other implementations, the drive mechanism 206 includes any combination of gear reduction systems for increasing torque by reducing motor speed, eccentric drive mechanisms for converting rotational motion into oscillating or reciprocating motion, belt drives that use belts and pulleys for torque or speed control, direct drive systems where the motor is directly connected to the working element, planetary gear drives for compact, high-torque applications, cam drives that convert rotary motion into linear motion, worm gear drives that deliver high torque at low speeds, hydraulic drives using pressurized fluid for force generation, pulley drives for torque transfer in specialized tools, rack and pinion systems that convert rotational motion into linear motion, linear actuators that transform rotary motion into linear movement, magnetic drives using magnetic fields for motion, and/or clutch drives that engage or disengage power for torque control, etc.

In other examples, the output element 208 includes any combination of drill bits for boring holes, screwdriver bits for driving screws, saw blades for cutting materials, grinding wheels for grinding or polishing, sanding pads for smoothing surfaces, impact anvils for delivering high torque, nail gun heads for firing nails, chisels for cutting or shaping materials, oscillating blades for precise cuts, polishing pads for finishing surfaces, planer blades for shaving wood, router bits for cutting and shaping, stapler heads for firing staples, reciprocating saw blades for rough cutting, cutting discs for cutting metal or stone, diamond blades for cutting stone or tile, chainsaw chains for cutting wood, hammer heads for driving nails or breaking surfaces, plunge cutters for plunge cuts, heat gun nozzles for directing hot air, air compressor nozzles for releasing compressed air, and/or deburring tools for removing rough edges after cutting, etc.

The power tool 102 may also include a grip 210 integrated into the housing and a switch 212 mounted on the housing 202, for example, located opposite the grip 210. The switch 212 may be electrically connected between the battery pack 104 and the motor 204 (for example, electrically connected to an electronic controller, as will be described in detail), allowing for the user to selectively operate the motor 204. For example, by activating the switch 212, the user can control the power tool 102 to power the motor 204 to drive the output element 208.

As illustrated in detail in FIG. 3, the power tool 102 includes a battery pack interface 302, which may form the power tool side of a standardized interface format. The battery pack interface 302 ensures that the battery pack 104 may be removably and securely connected to and/or communicate with the power tool 102. For example, the battery pack interface 302 may include components that provide mechanical, electrical, and/or data connections between the power tool 102 and the battery pack 104. In the example of FIG. 3, the battery pack interface 302 includes a biasing member 304 positioned inside a cavity 306 formed at a distal end 214 of the power tool 102.

In various implementations, the biasing member 304 is formed of a single piece of metallic material, although other suitable materials may be used. In the example of FIG. 3, the biasing member 304 includes of a first spring arm 304a, a second spring arm 304b, and a cross member 304c that connects the two spring arms 304a and 304b. Both spring arms 304a and 304b may extend generally parallel to the longitudinal axis 216 of the power tool 102 and may be directed toward the distal end 214. Each spring arm 304a and 304b may include a respective projection 308a and 308b that extends transversely (e.g., perpendicularly to the longitudinal axis 216). The projections 308a and 308b may engage with corresponding rails 502a and 502b on the battery pack 104, forming a locking engagement that secures the battery pack 104 in place. In other examples, the spring arms 304a and 304b may be constructed from separate materials, with the biasing member 304 including multiple pieces.

The battery pack interface 302 may include a pair of electrical terminals 310 that are located within the cavity 306 and extend toward the distal end 214 (for example, running generally parallel to the longitudinal axis 216). The power terminals 310 may provide an electrical connection between the power tool 102 and the battery pack 104 for transferring electrical power between the power tool 102 and the battery pack 104. The battery pack interface 302 may also include a communication terminal 312, which provides an electrical connection between the power tool 102 and the battery pack 104 for transmitting communication signals from the power tool 102 to the battery pack 104 and/or from the battery pack 104 to the power tool 102.

As illustrated in the example of FIG. 3, the housing 202 may include an inner surface 314 and an outer surface 316. The battery pack interface 302 may include latch contact surface 318a and 318b, which may be located on the inner surface 314 of the housing near latch-receiving recesses 320a and 320b. The latch-receiving recesses 320a and 320b may be dimensioned with a depth 322 (for example, measured along the longitudinal axis 216 of the power tool 102) such that latch contact surfaces 318a and 318b engage corresponding latches 504a and 504b of the battery pack 104. Thus, the latch contact surfaces 318a and 318b may form a secondary locking mechanism, ensuring that the battery pack 104 remains securely retained even in scenarios where the other mechanisms may disengage.

The battery pack interface 302 may also include elastomer pads 324 located on the inner surface 314 of the housing 202. The elastomer pads 324 may cushion the battery pack 104, absorbing vibrations that may occur during tool operation. The elastomer pads 324 may be overmolded into the housing 202. In various implementations, the elastomer pads 324 are constructed from elastic or damping materials such as rubber, silicone, polyurethane elastomer, or other polymers. Additionally, the housing 202 may include a chamfer 326 positioned at an edge of the housing 202 near the distal end 214. The chamfer 326 may function as a lead-in guide for the battery pack 104, ensuring smooth insertion into the cavity 306. The chamfer 326 may also aid in centering the battery pack 104, preventing it from twisting or rotating during insertion or removal.

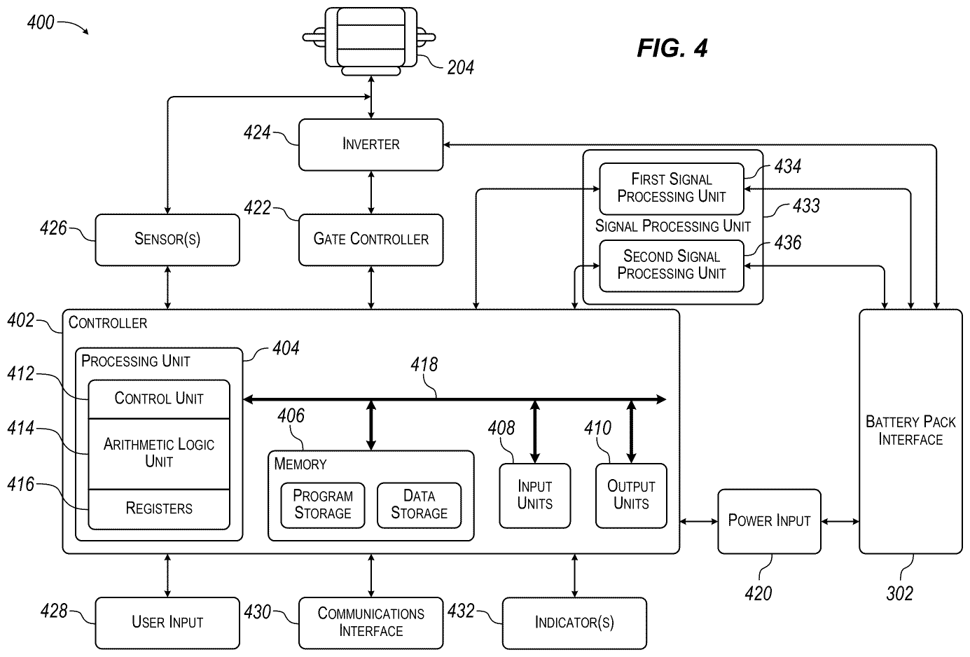

FIG. 4 is a block diagram illustrating an example control system 400 for the power tool 102, according to some embodiments. In various implementations, portions of the control system 400 can be integrated into or connected to a printed circuit board (PCB) and can include an electronic controller 402. The electronic controller 402 may include hardware and/or software designed to manage the operation of various components the power tool 102. The electronic controller 402 may include various electrical and/or electronic components that provide power, operational control, and/or protection to the components and/or modules within the electronic controller 402 and/or the power tool 102. For example, the electronic controller 402 includes a processing unit 404 (such as a microprocessor, a microcontroller, an electronic processor, an electronic controller, or other suitable programmable devices), a memory 406, input units 408, and/or output units 410. The processing unit 404 may include components such as a control unit 412, an arithmetic logic unit (ALU) 414, and/or a set of registers 416 (depicted in FIG. 4 as a group of registers). The processing unit 404 may use computer architectures such as a modified Harvard architecture, a von Neumann architecture, or other suitable architectures.

The processing unit 404, memory 406, input units 408, output units 410, and/or other modules connected to the electronic controller 402 may be interconnected via one or more control and/or data buses such as a common bus 418. While these buses are shown generally in FIG. 4 for illustrative purposes, the use of one or more control and/or data buses for the interconnection between and communication among the various modules and/or components would be known to a person skilled in the art in view of the embodiments described herein.

The memory 406 may include a non-transitory computer-readable medium that includes, for example, a program storage area and/or a data storage area. The program storage area and data storage area can include any combination of different types of memory, such as read-only memory (ROM), random access memory (RAM), such as, for example, dynamic RAM [DRAM], synchronous DRAM [SDRAM], etc., electrically erasable programmable read-only memory (EEPROM), flash memory, one or more hard drives, one or more SD cards, and/or other suitable magnetic, optical, physical, and/or electronic memory devices. The processing unit 404 may be connected to the memory 406 and may execute software instructions that are capable of being stored in a RAM of the memory 406 (such as during execution), a ROM of the memory 406 (such as on a generally permanent basis), and/or another non-transitory computer-readable medium such as another memory or a disc.

The software stored in memory 406 may control various functions of the power tool 102. For example, the functional blocks, flowcharts elements, and technical explanations described herein may serve as software specifications, which can be translated into the computer programs by the routine work of a skilled technician or programmer. This software may include firmware, applications, program data, filters, rules, program modules, and/or other executable instructions. The electronic controller 402 may retrieve and execute these instructions to control the operation of the power tool 102. In other configurations, the electronic controller 402 may include additional, fewer, and/or different components depending on the specific implementation.

The electronic controller 402 may be electrically and/or communicatively connected to and/or control operation of various modules and/or components of the power tool 102. In the example of FIG. 4, the power tool 102 includes a power input module 420, which regulates and manages the electrical power delivered from the battery pack interface 302 to the electronic controller 402 and other components of the power tool 102. For example, the power input module 420 receives direct current (DC) power from the battery pack 104 via the electrical terminals 310. The power input module 420 may include a combination of active and passive components, such as voltage regulators, current limiters, capacitors, and/or filtering circuits that adjust the voltage to appropriate levels required by the electronic controller 402 and/or other components. In various implementations, the power input module 420 filters noise from the DC power before providing the filtered power to the electronic controller 402 and/or other components.

In the example of FIG. 4, the power tool 102 includes a gate controller 422 and an inverter 424 for driving the motor 204. The motor 204 may include a rotor, a stator, and a shaft. The stator may be the stationary part of the motor 204 and include coils of wire (which may be referred to as windings) through which current flows, creating a rotating magnetic field. The rotor may be positioned within the stator and may be the moving part that rotates when acted upon by the magnetic field generated by the stator. The rotor may be connected to a shaft, which rotates about a longitudinal axis, transmitting the mechanical force generated by the motor 204 to the drive mechanism 206.

The motor 204 may be electrically connected to and receive power from the inverter 424. The inverter 424 may receive DC from the battery pack 104 via the battery pack interface 302 and may convert the DC into phase signals. The phase signals may be applied to the stator windings in a controlled sequence, creating the magnetic fields that drive the rotor's rotation. For example, the gate controller 422 may be electrically connected to the inverter 424 and regulate the operation of switches (such as field-effect transistors [FETs]) within the inverter 424, determining when and how the DC power is converted into phase signals. The electronic controller 402 may be electrically connected to and generate and send control signals to the gate controller 422, instructing the gate controller 422 how to manage the operation of the switches of the inverter 424. Managing the timing and modulation of the switches of the inverter 424 allows for precise adjustments to frequency an amplitude of the power supplied to the motor 204, which allows for precise control of the speed, torque, and direction of the motor 204.

In various implementations, the power tool 102 implements advanced control techniques such as field weakening to optimize performance of the motor 204 under various operating conditions. Field weakening may be implemented to achieve higher output speeds at the motor 204 by reducing the strength of the magnetic field generated by the stator. This may be accomplished by adjusting the phase and amplitude of the phase signals applied to the stator windings. By decreasing the magnetic field strength at higher speeds, the motor 204 may be able to operate beyond its base speed, allowing the motor 204 to maintain efficiency while preventing saturation of the magnetic circuit.

For example, the electronic controller 402 may send control signals to the gate controller 422, which adjusts the phase signals output from the inverter 424 to implement field weaking by dynamically altering the current applied to the stator windings of the motor 204. For example, during high-speed operation, the electronic controller 402 may command the gate controller 422 to reduce the field current while increasing the rotor's rotational speed. This reduces the back electromotive force (EMF) generated by the rotor, allowing the motor 204 to operate at higher speeds without exceeding voltage limits of the battery pack 104 or inverter 424.

In various implementations, the power tool 102 includes one or more sensors 426. The electronic controller 402 may be electrically connected to and receive sensor signals from the one or more sensors 426 to monitor various components within the power tool 102. For example, the sensors 426 may include any combination of current sensors for monitoring the electrical current supplied to the motor 204, position sensors for detecting the position of moving components within the power tool 102, temperature sensors to monitor the temperature of components such as the motor 204 or inverter 424, voltage sensors to track the voltage supplied by the battery pack 104, pressure sensors for detecting air or hydraulic pressure in pneumatic systems, torque sensors for measuring the torque applied by the motor 204, acceleration sensors to monitor rapid changes in speed or direction, vibration sensors for detecting excessive vibrations that could indicate wear or damage, proximity sensors to detect the presence or distance of nearby objects, speed sensors to monitor the rotational speed of the shaft of the motor 204, Hall effect sensors for detecting magnetic fields to measure position or speed of various components of the motor 204, strain gauges to measure deformation or stress on structural components, optical sensors to detect light-based changes such as component alignment or motion, gyroscopic sensors for monitoring orientation and angular velocity, and load sensors for detecting the force or weight applied during operation.

The electronic controller 402 may be electrically connected to one or more user inputs 428. The user inputs 428 may include the switch 212 and/or any combination of digital and/or analog devices, including knobs, dials, switches, buttons, touchscreens, etc. In various implementations, the controller 402 detects user interactions with the user input 428 and changes an operating parameter of the motor 204 (such as starting the motor, stopping the motor, adjusting the speed of the motor, adjusting the torque output by the motor, switching the direction of rotation of the motor, etc.). In some examples, the power tool 102 includes a communications interface 430, such as a Bluetooth, Wi-Fi, and/or other wireless communication module. The communications interface 430 may allow the electronic controller 402 to receive wireless signals from external devices (such as smartphones, tablets, or other control systems, etc.) and control various operational aspects of the power tool 102 accordingly.

In various implementations, the power tool 102 includes one or more indicators 432. The indicators 432 may include various types of display elements, such as light-emitting diodes (LEDs), display screens, or other types of visual or audible indicators. The indicators 432 may be electrically connected to the electronic controller 402, and the electronic controller 402 may control the indicators to output operational statuses of the power tool 102 to the user (such as, for example, indications of motor running, motor idle, battery level, low battery warning, charging status, fault detection, motor overload, over-temperature warning, mode selection [e.g., forward/reverse], torque setting, and/or maintenance or service alerts, etc.).

As previously described, the power tool 102 and the battery pack 104 may transmit and receive both analog and digital communications over a single pin or terminal, such as communication terminal 312. For example, the battery pack 104 may simultaneously transmit both analog and digital communications signal by superimposing a digital signal onto an analog signal. The power tool 102 may receive the combined signal via the battery pack interface 302. In the example of FIG. 4, the power tool 102 includes a signal processing unit 433. The signal processing unit 433 includes a first signal processing unit 434 that is responsible for handling the analog component of the signal and a second signal processing unit 436 that is responsible for handling the digital component. These signal processing units 434 and 436 may operate in tandem within a voltage tracking configuration, ensuring that the analog and digital components are properly processed without interference.

In this configuration, the first signal processing unit 434 includes a voltage tracking circuit that monitors the base analog signal, which may include steady, continuous voltage levels representing an analog signal. The voltage tracking circuit recognizes fluctuations or peaks in the voltage as being part of the superimposed digital signal and isolates the fluctuations or peaks from the analog data. Thus, the first signal processing unit 434 isolates the stable, low-frequency analog components of the combined signal as the analog component and ignores high-frequency variations (which may correspond to the digital component).

The second signal processing unit 436 may focus on the digital portion of the signal, which may be encoded in the form of high-frequency voltage peaks superimposed on the base analog waveform. The second signal processing unit 436 may include a voltage tracking circuit that identifies these high-frequency variations, which the second signal processing unit 436 captures and decodes as the digital component. Thus, the first signal processing unit 434 and the second signal processing unit 434 may use the voltage tracking configuration to process the analog and digital components of the combined signal in parallel. In various implementations, the first signal processing unit 434 and the second signal processing unit 436 respectively encode and send the analog and digital components of the combined signal to the electronic controller 402.

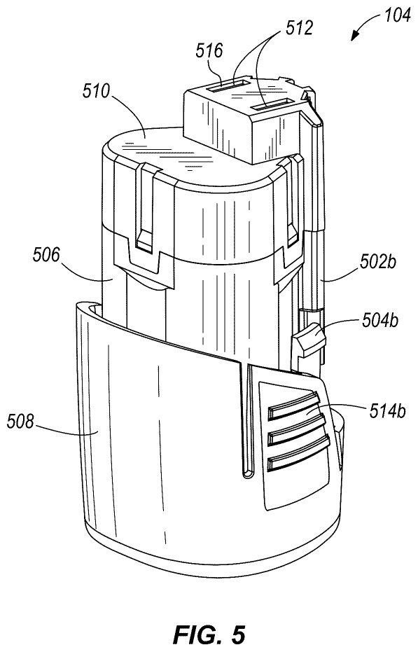

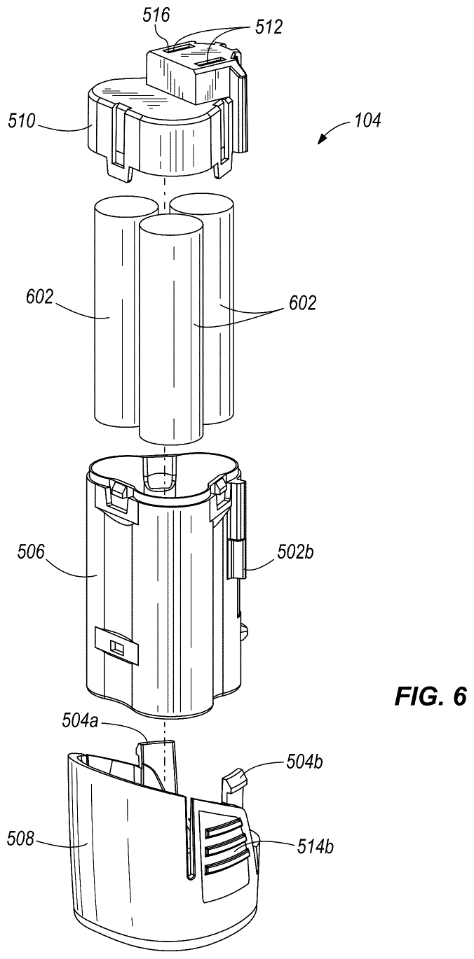

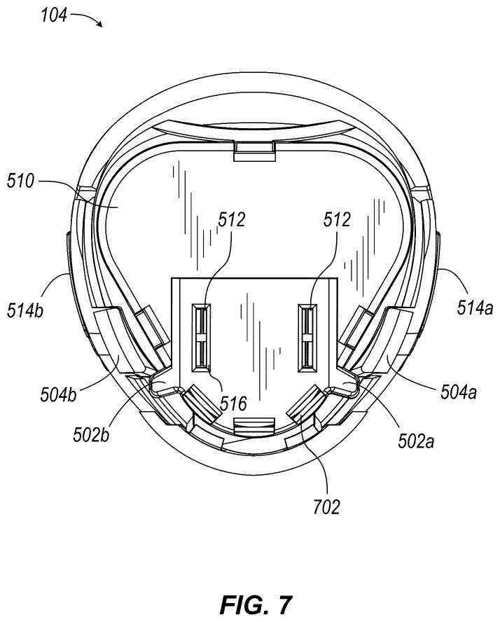

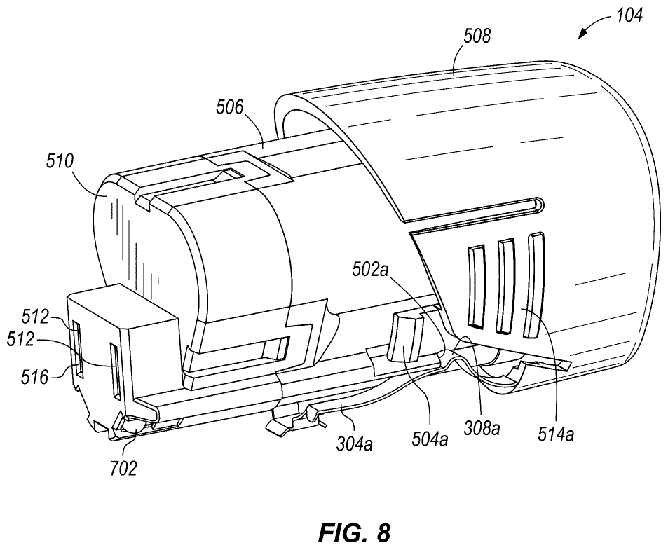

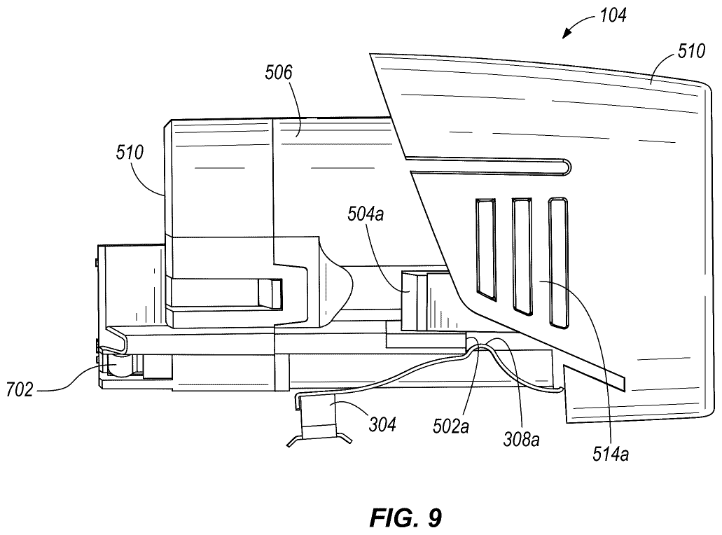

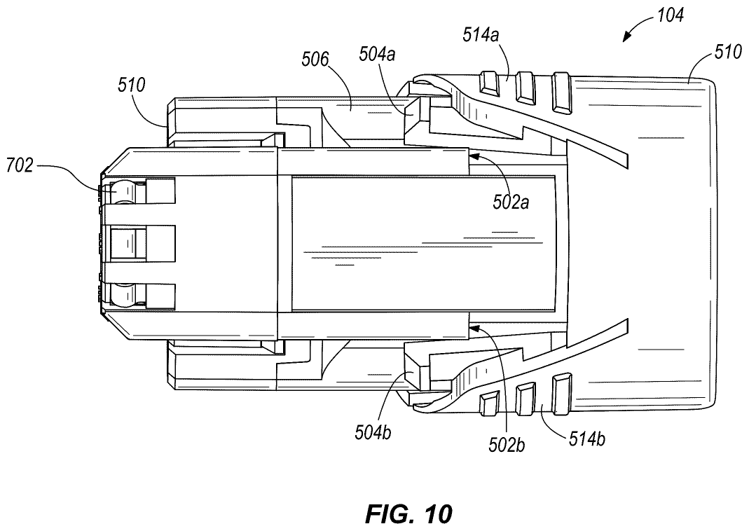

FIG. 5 is an isometric view of an example battery pack 104, according to some embodiments. FIG. 6 is an exploded view of the example battery pack 104 of FIG. 5, according to some embodiments. FIG. 7 is a top view of the example battery pack 104 of FIG. 5, according to some embodiments. FIG. 8 is another isometric view of the example battery pack 104 of FIG. 5, according to some embodiments. FIG. 9 is a side view of the example battery pack 104 of FIG. 5, according to some embodiments. FIG. 10 is a rear view of the example battery pack 104 of FIG. 5, according to some embodiments. Referring collectively to FIGS. 5-10, the battery pack 104 may be designed for use with the power tool 102. For example, the battery pack 104 may be a rechargeable battery pack, such as a nickel-cadmium (NiCd) battery pack, a nickel-metal hydride (NiMH) battery pack, a lithium-ion (Li-ion) battery pack, a lithium polymer (LiPo) battery pack, a solid-state battery pack, a zinc-air battery pack, a graphene battery pack, or any other suitable type of battery pack.

The battery pack 104 may be removably and interchangeably connected to various examples of the power tool 102. For example, various components of the battery pack 104 may be configured to interface with corresponding components of the battery pack interface 302 of the power tool 102, ensuring both mechanical and electrical compatibility across a range of power tools 102 having the standardized battery pack interface 302. The battery pack 104 may include various components for power delivery and data exchange between the battery pack 104 and the power tool 102. For example, the battery pack 104 includes one or more battery cells 602 positioned within a casing 506. The battery cells 602 may be arranged in parallel and/or in series and provide DC power to the power tool 102. In various implementations, each battery cell 602 has a nominal voltage of about 4.0 volts, providing the battery pack 104 with a combined nominal voltage of about 12 volts.

The cells 602 may be electrically connected to power terminals 512, which may be positioned on an end cap 510 of the casing 506. The power terminals 512 may be disposed within receptacles 516, which partially enclose the power terminals 512, providing both protection and alignment during connection with the power tool 102. The receptacles 516 may be positioned on the end cap 510 and shaped and dimensioned to mate with corresponding power terminals 310 of the battery pack interface 302. The receptacles 516 may ensure that the power terminals 512 are properly aligned and shielded during operation of the power tool 102, while also protecting the power terminals 310 and 512 from the external environment. In addition to the power terminals 512, the end cap 510 may also include communications terminals 702, which may be responsible for data exchange between the battery pack 104 and the power tool 102.

When the battery pack 104 is inserted into the cavity 306 of the power tool 102, the power terminals 512 of the battery pack 104 and the power terminals 310 of the power tool 102 are brought into contact to form an electrical connection, and the communication terminal 702 of the battery pack 104 and the communication terminal 312 of the power tool 102 are brought into contact to form an electrical connection. As the battery pack 104 is fully inserted, the receptacles 516 (and additional mechanical features described below) ensure proper alignment, guiding the power terminals 512 into contact with the power terminals 310 and guiding the communication terminal 702 into contact with the communication terminal 312.

In various implementations, the battery pack 104 incorporates various mechanical features that facilitate secure attachment and easy removal from the power tool 102. For example, the casing 506 may be shaped and dimensioned to fit precisely into the cavity 306 of the power tool 102, forming a robust connection that aligns the various corresponding terminals for reliable operation. The battery pack 104 may include an outer housing 508 that at least partially encloses the casing 506. The outer housing 508 may attach to an end of the casing 506 opposite the end cap 510 and at least partially surround the casing 506 to create a contour that aligns with a corresponding contour of the outer surface 316 of the power tool 102, aligning the various corresponding terminals when the battery pack 104 is connected to the power tool 102.

Additionally, the battery pack 104 may be equipped with rails 502a and 502b that extend along the sides of the casing 506. The rails 502a and 502b may engage with corresponding spring arms 304a and 304b (respectively) located inside the cavity 306 of the power tool 102, aligning the battery pack 104 with the power tool 102 and forming a primary locking engagement mechanism. This secure connection ensures that the battery pack 104 remains firmly in place during operation, even in the presence of vibrations or other external forces.

Furthermore, the battery pack 104 may include actuators 514a and 514b integrated into the outer housing 508, which control a set of latches 504a and 504b. These latches engage with latch contact surfaces 318a and 318b inside the power tool 102, aligning the battery pack 104 with the power tool 102 providing a secondary locking mechanism. In the event that the primary locking mechanism disengages or fails, the secondary mechanism ensures that the battery pack remains attached to the power tool 102. The actuators 514a and 514b allow the user to easily disengage the latches, enabling quick removal of the battery pack without the need for additional tools.

As previously described, power tool 102 may also include elastomer pads 324 positioned inside the cavity 306 of the power tool. These pads act as vibration dampers, cushioning the battery pack 104 during tool operation and reducing the wear and tear on both the battery pack 104 and the power tool 102. The inclusion of chamfers 326 along the edges of the cavity 306 further facilitates smooth insertion and removal of the battery pack 104 by guiding it into place and preventing twisting or misalignment during engagement or disengagement. These chamfers 326 also ensure that the battery pack 104 aligns correctly with the terminals and locking mechanisms, contributing to the overall ease of use and long-term durability of the system.

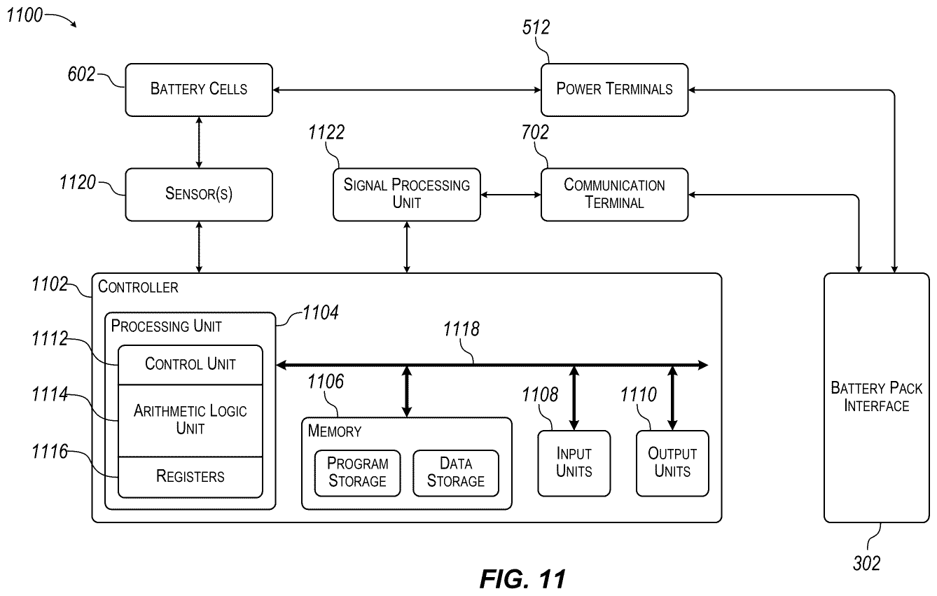

FIG. 11 is a block diagram illustrating an example control system 1100 for the battery pack 104, according to some embodiments. In various implementations, portions of the control system 1100 can be integrated into or connected to a printed circuit board (PCB) and can include an electronic controller 1102. The electronic controller 1102 may include hardware and/or software designed to manage the operation of various components the battery pack 104. The electronic controller 1102 may include various electrical and/or electronic components that provide power, operational control, and/or protection to the components and/or modules within the electronic controller 1102 and/or the battery pack 104. For example, the electronic controller 1102 includes a processing unit 1104 (such as a microprocessor, a microcontroller, an electronic processor, an electronic controller, or other suitable programmable devices), a memory 1106, input units 1108, and/or output units 1110. The processing unit 1104 may include components such as a control unit 1112, an arithmetic logic unit (ALU) 1114, and/or a set of registers 1116 (depicted in FIG. 11 as a group of registers). The processing unit 1104 may use computer architectures such as a modified Harvard architecture, a von Neumann architecture, or other suitable architectures.

The processing unit 1104, memory 1106, input units 1108, output units 1110, and/or other modules connected to the electronic controller 1102 may be interconnected via one or more control and/or data buses such as a common bus 1118. While these buses are shown generally in FIG. 11 for illustrative purposes, the use of one or more control and/or data buses for the interconnection between and communication among the various modules and/or components would be known to a person skilled in the art in view of the embodiments described herein.

The memory 1106 may include a non-transitory computer-readable medium that includes, for example, a program storage area and/or a data storage area. The program storage area and data storage area can include any combination of different types of memory, such as read-only memory (ROM), random access memory (RAM), such as, for example, dynamic RAM (DRAM), synchronous DRAM (SDRAM), etc., electrically erasable programmable read-only memory (EEPROM), flash memory, one or more hard drives, one or more SD cards, and/or other suitable magnetic, optical, physical, and/or electronic memory devices. The processing unit 1104 may be connected to the memory 1106 and may execute software instructions that are capable of being stored in a RAM of the memory 1106 (such as during execution), a ROM of the memory 1106 (such as on a generally permanent basis), and/or another non-transitory computer-readable medium such as another memory or a disc.

The software stored in memory 1106 may control various functions of the battery pack 104. For example, the functional blocks, flowcharts elements, and technical explanations described herein may serve as software specifications, which can be translated into the computer programs by the routine work of a skilled technician or programmer. This software may include firmware, applications, program data, filters, rules, program modules, and/or other executable instructions. The electronic controller 1102 may retrieve and execute these instructions to control the operation of the battery pack 104. In other configurations, the electronic controller 1102 may include additional, fewer, and/or different components depending on the specific implementation.

The electronic controller 1102 may be electrically and/or communicatively connected to and/or control operation of various modules and/or components of the power tool 102. In the example of FIG. 11, the battery pack 104 includes one or more sensors 1120 for monitoring the battery cells 602. The one or more sensors 1120 may be electrically connected to the electronic controller 1102 and may include a range of sensors capable of monitoring different operational parameters of the battery pack 104. For example, the sensors 1120 may include temperature sensors for monitoring the temperature of the battery cells 602, ensuring that they do not exceed a predefined safe temperature range during use or charging. If a sensor 1120 detects that the temperature has risen above a safe threshold, the sensor signal can indicate to the electronic controller 1102 that a cooling process or a power reduction is needed to prevent overheating and potential damage to the battery cells 602.

In some implementations, the sensors 1120 include voltage sensors to monitor the voltage levels of individual cells or the overall battery pack 104. These voltage sensors can ensure that the battery cells 602 maintain appropriate charge levels and can alert the electronic controller 1102 to potential under-voltage or over-voltage conditions, helping to prevent performance issues or potential damage to the cells. The sensors 1120 may include current sensors to measure the amount of current being drawn from or delivered to the battery pack 104 during operation or charging. This information may allow the electronic controller 1102 to manage power output and charging rates dynamically based on current draw, optimizing the performance of the power tool 102 and extending battery life.

In some examples, the electronic controller 1102 uses signals from the sensors 1120 to inform advanced control strategies, such as balancing the charge between cells to ensure uniform wear across the battery pack 104 and/or to trigger maintenance alerts. The sensor signals may provide the electronic controller 1102 with real-time data to monitor the health and performance of the battery pack 104, enabling smart power management and protecting the system from damage under various operating conditions.

In the example of FIG. 11, the battery pack 104 includes a signal processing unit 1122, which is electrically connected with the electronic controller 1102. The signal processing unit 1122 may be responsible for generating the previously described combined signal by superimposing a digital signal onto an existing analog signal, allowing both analog and digital data to be transmitted over a single communication line. The combined signal provides for backward compatibility with legacy power tools that rely on analog communication, while supporting digital communication for modern power tools implementing more advanced functionality. In various implementations, the signal processing unit 1122 receives the analog signal (e.g., from the electronic controller 1102). The analog signal may be a low-frequency continuous voltage signal. The analog signal may represent operational parameters of the battery pack 104, such as voltage or temperature (e.g., as indicated by the sensors 1120).

The signal processing unit 1122 may superimpose the digital signal onto the analog signal, for example, using one of several modulation techniques. In various implementations, the signal processing unit 1122 implements time-division multiplexing (TDM), in which the analog and digital signals are transmitted sequentially in separate time slots. The communication channel may be divided into intervals, where the analog signal is sent during one time slot, followed by the digital signal in the next. This time-based separation ensures that both signals can share the same communication line without interference or overlap. In some examples, the signal processing unit 1122 implements frequency-division multiplexing (FDM), where the digital signal is transmitted at a higher frequency that the analog signal. The analog signal occupies the lower frequency range, while digital data is modulated into the higher frequency range, allowing both signals to coexist in separate frequency bands.

In various implementations, the signal processing unit 1122 implements amplitude-shift keying (ASK), where the digital signal is represented by variations in the amplitude of the combined waveform. The base analog signal remains steady, while the digital signal is encoded as fluctuations in amplitude, producing distinct peaks or dips in the waveform. In some examples, the signal processing unit 1122 implements phase-shift keying (PSK), in which the digital signal is represented by shifts in the phase of the base analog waveform at specific intervals. PSK allows the digital signal to be superimposed onto the analog signal without altering its frequency or amplitude, ensuring simultaneous transmission of both signals. Thus, the signal processing unit 1122 may ensure that both the analog and digital components of the combined signal coexist harmoniously and can be transmitted over the same communication line.

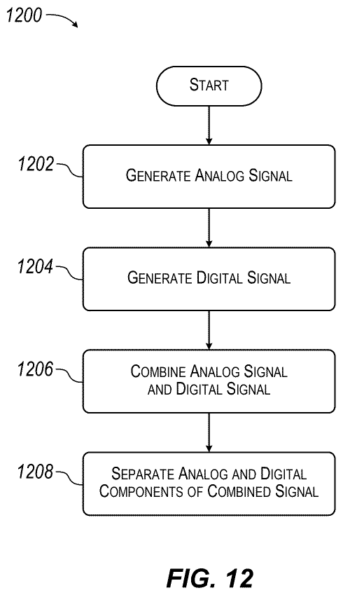

FIG. 12 is a flowchart illustrating an example process 1200 for simultaneous analog and digital communication between a battery pack 104 and a power tool 102, according to some embodiments. In the example process 1200, an analog signal is generated, for example at the battery pack 104 (at operation 1202). The analog signal may be generated according to any of the previously described techniques. For example, the electronic controller 1102 may generate the analog signal to represent an operational parameter of the battery pack 104, such as voltage or temperature. In the example process 1200, a digital signal is generated, for example, at the battery pack 104 (at operation 1204). The digital signal may be generated according to any of the previously described techniques. For example, the electronic controller 1102 may generate the digital signal to represent advanced information, such as the state of charge, health status of the battery cells 602, identification codes, usage history, diagnostic data, etc.

In the example process 1200, analog and digital signals are combined, for example, at the battery pack 104 (at operation 1206). For example, the electronic controller 1102 transmits the analog signal and the digital signal to the signal processing unit 1122 and the signal processing unit 1122 combines the analog signal and the digital signal into the combined (or composite) signal. The signal processing unit 1122 may combine the analog and digital signals according to any of the previously described techniques, or other techniques.

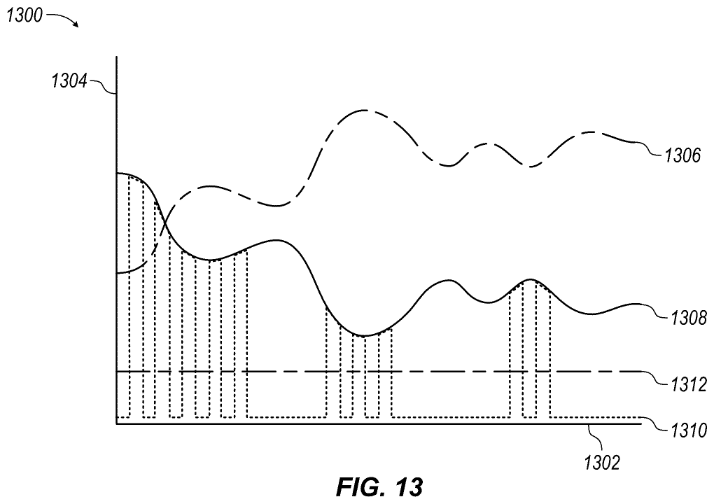

FIG. 13 is a chart 1300 illustrating an example of a combined signal, according to some embodiments. The chart 1300 includes a first axis 1302 representing time and a second axis 1304 representing voltage. In the chart 1300, the line 1306 represents an operational parameter of the battery pack 104 over time, such as temperature or voltage measurements (the second axis 1304 may, for the line 1306, correspond to a magnitude of the unit of the operational parameter, such as a temperature unit, as appropriate). In the chart 1300, the line 1308 represents the analog signal generated based the operational parameter represented by line 1306. In the example of the chart 1300, the amplitude of analog signal exhibits an inverse relationship with amplitude of the operational parameter (e.g., when the amplitude of the line 1306 increases, the amplitude of the line 1308 decreases, and while the amplitude of the line 1306 decreases, the amplitude of the line 1308 increases). In other examples, the amplitude of the analog signal is correlated to the amplitude of the operational parameter.

In the chart 1300, the line 1310 illustrates the combined signal, where the digital signal is superimposed onto the analog signal by modifying the amplitude of the analog signal at specific intervals. In the combined signal, the digital component manifests as discrete amplitude (e.g., voltage) fluctuations or pulses. When the digital component represents a logical “1,” the amplitude of the combined signal remains above a threshold level indicated by the horizontal line 1312. Conversely, when the digital signal represents a logical “0,” the amplitude drops below the threshold 1312, creating distinct pulses. In other examples, when the digital component represents a logical “0,” the amplitude of the combined signal remains above a threshold level indicated by the horizontal line 1312, while when the digital signal represents a logical “1,” the amplitude drops below this threshold.

Returning to FIG. 12, in the example process 1200, the analog and digital components of the combined signal are separated, for example, at the power tool 102 (at block 1208). In various implementations, the signal processing unit 1122 transmits the combined signal to the first signal processing unit 434 and the second signal processing unit 436 via battery pack interface 302. The first signal processing unit 434 and the second signal processing unit 436 may separate the analog and digital components of the combined signal according to any of the previously describe techniques and transmit the respective components to the electronic controller 402 of the power tool 102.

While the example process 1200 is described above in the context of generating the combined signal at the battery pack 104 and separating the combined signal at the power tool 102, in other embodiments, the combined signal may be generated at the power tool 102 (using analogous components and techniques as those previously described) and separated at the battery pack 104 (using analogous components and techniques as those previously described).

Thus, embodiments described herein provide, among other things, systems and methods for providing simultaneous analog and digital communication over a standardized interface terminal. Various features and advantages are set forth in the following claims.

What is claimed is:

1. A power tool, comprising:
a battery pack interface;
a signal processing unit connected to the battery pack interface; and
an electronic controller connected to the signal processing unit;
wherein the battery pack interface is configured to receive a composite signal from a battery pack;
wherein the signal processing unit is configured to separate the composite signal into an analog component and a digital component; and
wherein the electronic controller is configured to receive the analog component and the digital component from the signal processing unit.

2. The power tool of claim 1, wherein the signal processing unit includes a first signal processing unit configured to isolate the analog component from the composite signal.

3. The power tool of claim 2, wherein the first signal processing unit includes a voltage tracking circuit.

4. The power tool of claim 3, wherein the voltage tracking circuit tracks substantially continuous voltage levels of the composite signal, wherein the substantially continuous voltage levels represent the analog component.

5. The power tool of claim 2, wherein the signal processing unit includes a second signal processing unit configured to isolate the digital component from the composite signal.

6. The power tool of claim 5, wherein the second signal processing unit includes a voltage tracking circuit.

7. The power tool of claim 6, wherein the voltage tracking circuit identifies high-frequency voltage peaks of the composite signal, wherein the high-frequency voltage peaks represent the digital component.

8. The power tool of claim 1, wherein the composite signal is generated at a battery pack that is configured to be received by the battery pack interface.

9. The power tool of claim 8, wherein the composite signal includes a digital signal superimposed onto an analog signal.

10. The power tool of claim 9, wherein the analog signal represents an operational parameter of the battery pack.

11. A battery pack system comprising:
a power tool including a battery pack interface; and
a battery pack including:
a communication terminal configured to connect to the battery pack interface of the power tool,
a signal processing unit connected to the communication terminal, and
an electronic controller connected to the signal processing unit,
wherein the electronic controller is configured to generate an analog signal and a digital signal,
wherein the signal processing unit is configured to superimpose the digital signal onto the analog signal to generate a composite signal, and
wherein the communication terminal is configured to transmit the composite signal to the battery pack interface.

12. The battery pack system of claim 11, wherein the analog signal represents an operational parameter of the battery pack.

13. The battery pack system of claim 11, wherein the power tool is configured to receive the composite signal and separate the composite signal into an analog component and a digital component.

14. The battery pack system of claim 13, wherein the power tool includes a first signal processing unit configured to isolate the analog component from the composite signal.

15. The battery pack system of claim 14, wherein the first signal processing unit includes a voltage tracking circuit.

16. The battery pack system of claim 15, wherein the voltage tracking circuit tracks substantially continuous voltage levels of the composite signal, wherein the substantially continuous voltage levels represent the analog component.

17. The battery pack system of claim 14, wherein the signal processing unit includes a second signal processing unit configured to isolate the digital component from the composite signal.

18. The battery pack system of claim 17, wherein the second signal processing unit includes a voltage tracking circuit.

19. The battery pack system of claim 18, wherein the voltage tracking circuit identifies high-frequency voltage peaks of the composite signal, wherein the high-frequency voltage peaks represent the digital component.

20. A system, comprising:
a power tool including a battery pack interface; and
a battery pack configured to connect to the battery pack interface;
wherein the battery pack is configured to superimpose a digital signal onto an analog signal to generate a composite signal;
wherein the battery pack is configured to transmit the composite signal to the power tool via the battery pack interface; and
wherein the power tool is configured to separate the composite signal into an analog component and a digital component.
